(19) United States
(12) Patent Application Publication
(10) Pub. No.: US 2005/0175210 A1
(43) Pub. Date: Aug. 11, 2005

(54) Color illuminating earphone

(76) Inventor: Peter Yang, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/775,196

(22) Filed: Feb. 11, 2004

(51) Int. Cl. H04R 25/00

(52) U.S. Cl. 381/371; 381/374; 381/370

(57) ABSTRACT

An improved portable earphone with a structure having color illuminating members in an independent unit and providing configurations for setting up the mode and type of the illumination according to the using conditions. The illuminating members show a blinking effect according to the frequency of the sound source or the independent constant speed, as well as providing a safety warning function.

### FIELD OF THE INVENTION

The present invention relates to an earphone, more particularly to an improved portable earphone with a structure having color illuminating members in an independent unit and providing configurations for setting up the mode and type of the illumination according to the using conditions, such that the illuminating members show a blinking effect according to the frequency of the sound source or the independent constant speed, as well as providing a safety warning function.

### BACKGROUND OF THE INVENTION

In general, the basic models of earphones or noise-resisting earpieces sold in the market have the functions of transmitting sound or preventing noises. The design of the present invention is to build an electronic circuit on an earphone, and make use of the frequency of the sound source and the sound volume to produce variations of color or monochrome light sources, allowing people around to see the portable earphone with an obvious illuminating warning effect, and the illuminating section includes an earplug or an earpiece, an earphone cable, and an ear hanger or ear frame. Thus, the invention provides an illumination for joggers at night and a warning effect for the drivers to notice the position of the joggers. The invention can be used by airport ground service staff, tunnel construction workers, or nighttime road construction workers. If a large color illuminating warning noise-proof earpiece is worn, then it can achieve a significant warning effect to enhance visibility of the position of the operator who wears the large color illuminating warning noise-proof earpiece.

There are many types of color illuminating earphones, such as those illuminating according to the frequency of sound, volume of sound, or blinking with a constant frequency, which is set by users freely. The position of the illumination can be set according to the user's purchase option, such as setting the illuminating position at the earplug or earpiece of an earphone, an earphone cable, an ear hanger, an ear frame, or a support frame at the top of a large noise-proof earphone. The color of the illumination can be set according to the types of the products, such as monochrome, multiple colors, or color, and the light source could be a lamp or an LED component.

### SUMMARY OF THE INVENTION

The primary objective of the invention is to provide an earphone which is a popular and safe creation having a color illuminating member for an independent unit, setting the earphone to various modes and types for the illumination according to the using conditions to show monochrome or colored beams in different occasions, setting up the frequency of sound source or providing the independent blinking at a constant speed, and also providing a safety warning function for special environments.

### BRIEF DESCRIPTION OF THE DRAWINGS

FIG. 1 is a perspective view of the color illuminating earphone according to a preferred embodiment of the present invention.

FIG. 2 is an exploded view of a control board of the color illuminating earphone according to a preferred embodiment of the present invention.

FIG. 3 is a perspective view of a control board of the color illuminating earphone according to a preferred embodiment of the present invention.

FIG. 4 is an exploded view of the earphone section of the color illuminating earphone according to a preferred embodiment of the present invention.

FIG. 5 is a perspective view of ear-hanging type color illuminating earphone according to a preferred embodiment of the present invention.

FIG. 6 is a perspective view of the back-hanging type earphone according to a preferred embodiment of the present invention.

FIG. 7 is a perspective view of the large color warning noise-proof earphone according to a preferred embodiment of the present invention.

FIG. 8 is a block diagram of the control circuit according to the present invention.

### DETAILED DESCRIPTION OF THE PREFERRED EMBODIMENTS

The detailed description and technical characteristics of the present invention are described together with the drawings as follows.

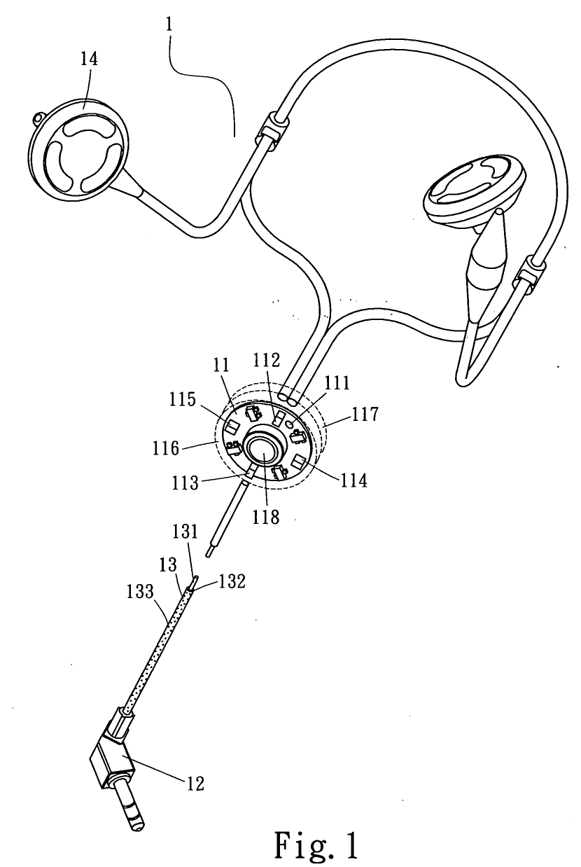

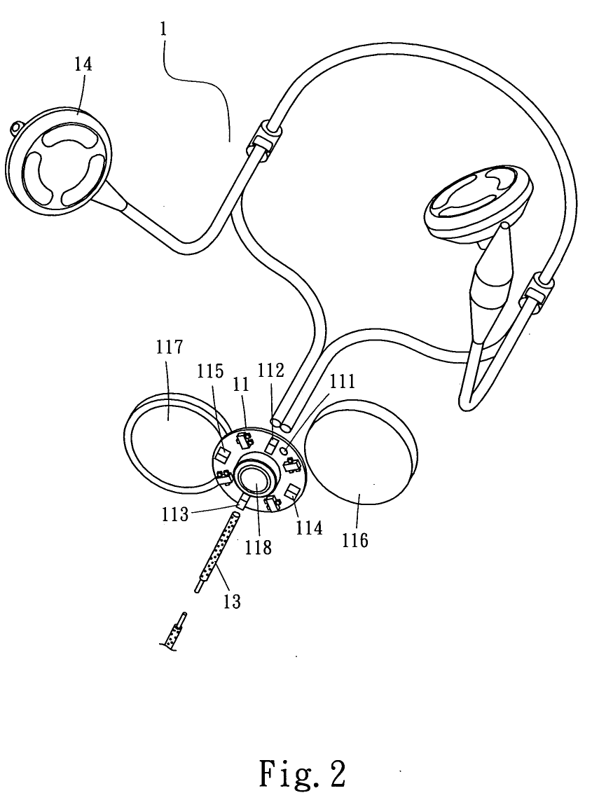

Please refer to FIGS. 1 and 2, the color illuminating earphone 1 according to the present invention comprises an electronic control board 11, a connector 12, an earphone illuminating wire 13, and an illuminating earplug or earpiece 14, wherein the earphone wire material 13 is disposed outside a core of the earphone illuminating wire 131 and wrapped with an earphone transparent material 132 having a light guiding effect.

The color illuminating earphone 1 according to the present invention comprises an electronic control board 11 thereon, a chip 111, and a plurality of illuminating components 112, 113, 114, 115, which can produce a blinking light source according to the frequency of the sound source or the volume of sound, and produce an illumination through the earphone wire 13, the upper transparent casing 116 of the control board 11 and the lower transparent casing 117 of the control board 11.

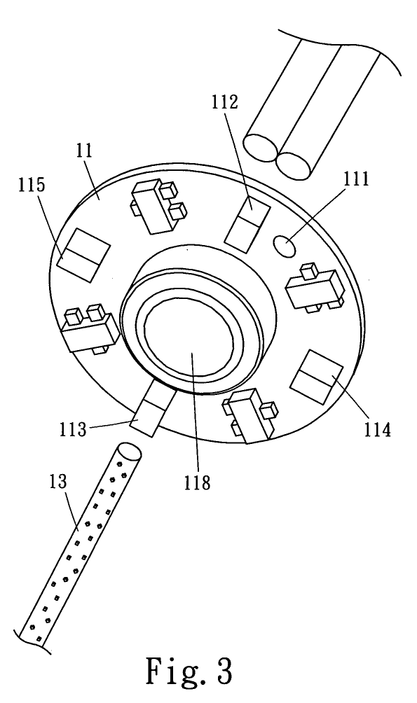

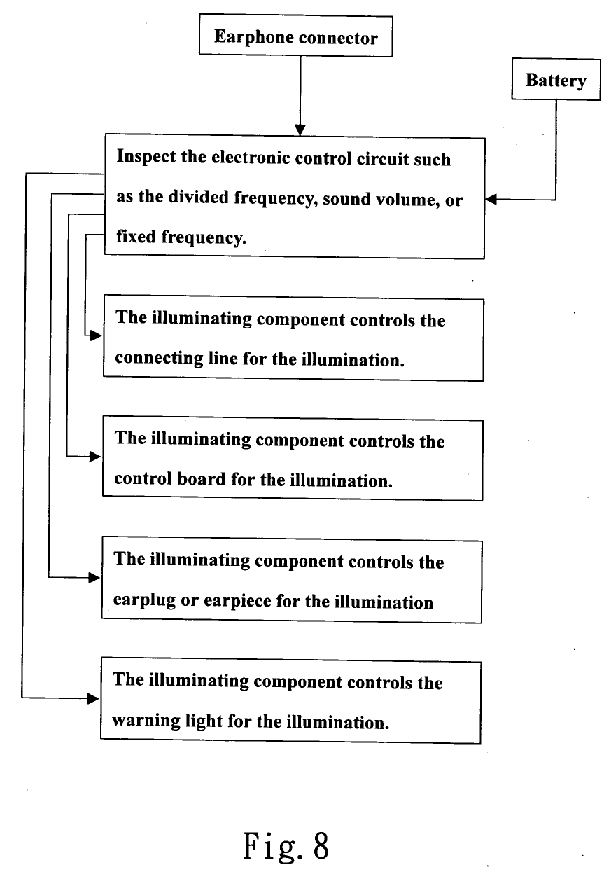

In FIG. 3, the illuminating components 112, 113, 114, 115 of the electronic control board 11 may vary the blinking illumination or warning according to the frequency of the inputted sound or the volume of sound, or has the constant blinking cycle to produce a monochrome or multiple-color light for the blinking function. Metal particles are added into the transparent earphone wrapping material for its wire formation, such that the light source produced by the illuminating components 112, 113, 114, 115 is projected onto the transparent material 132 of the earphone illuminating wire 13 through light guiding to produce a refraction of the light source to enhance the diffusion feature of light to the surroundings. Please refer to the control circuit block diagram as shown in FIG. 8 for the principle of controlling the illumination of the light source according to the invention.

In FIG. 8, the control circuit block diagram shows an electronic circuit chip 111 and a plurality of illuminating components 112, 113, 114, 115 on the electronic control board 11. After the audio signal provided by the earphone illuminating wire 13 is inputted to the electronic circuit chip 111 and the control circuit distinguishes different frequencies and sound volume of the signal source to control the blinking brightness and time of the control illuminating components 112, 113, 114, 115, and then the control illuminating components 112, 113, 114, 115 produce a light source and a projection effect through the light guiding material of the transparent material 132 wrapped around the earphone wire 13, or directly use the transparent upper casing 116 of the control board 11 and the lower casing 117 of the control board 11, which are transparent material having the light guiding property, to produce the radiation of the color light. The electronic control board 11 can be designed to carry a battery 118 or an electric power supply to supply power to the sound source.

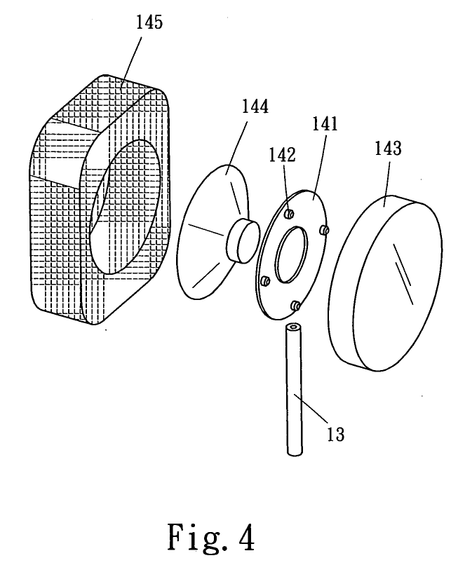

In FIG. 4, the illuminating earplug or earpiece 14 of various types of earphones according to the invention comprises a circuit board 141 having an illuminating component 142, a transparent casing 143, and a loudspeaker 144, such that the earpiece section also has an illuminating function. A sponge member 145 may be added to the earphone as needed.

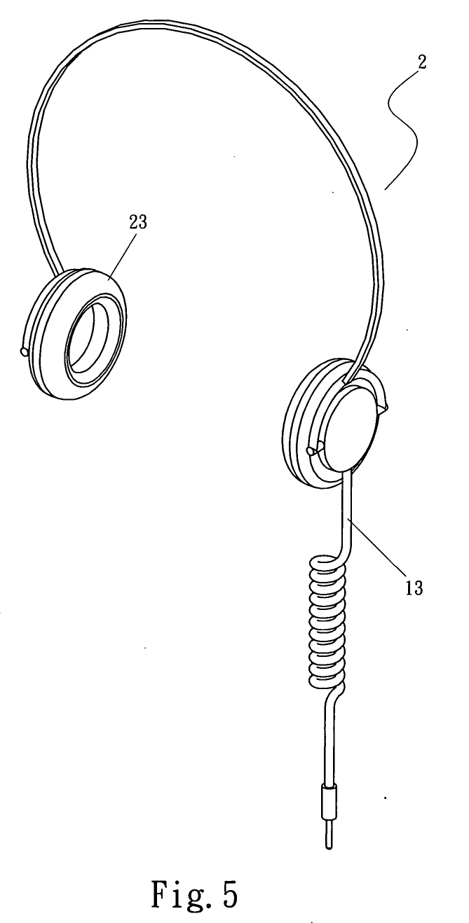

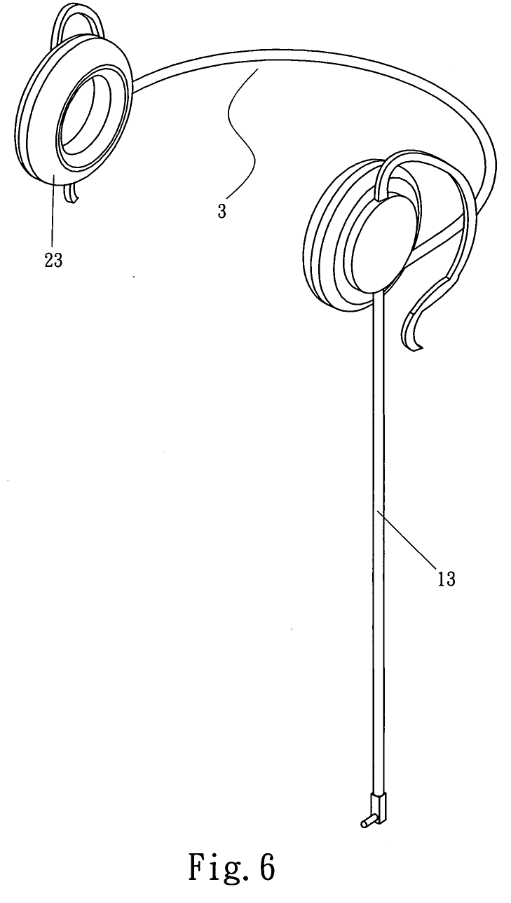

Please refer to FIGS. 5 and 6 for the actual object according to a preferred embodiment of the invention, which can be designed as an ear-hanging type earphone 2 and a back hanging type earphone 3 that includes an illuminating wire 13 and an illuminating earpiece 23.

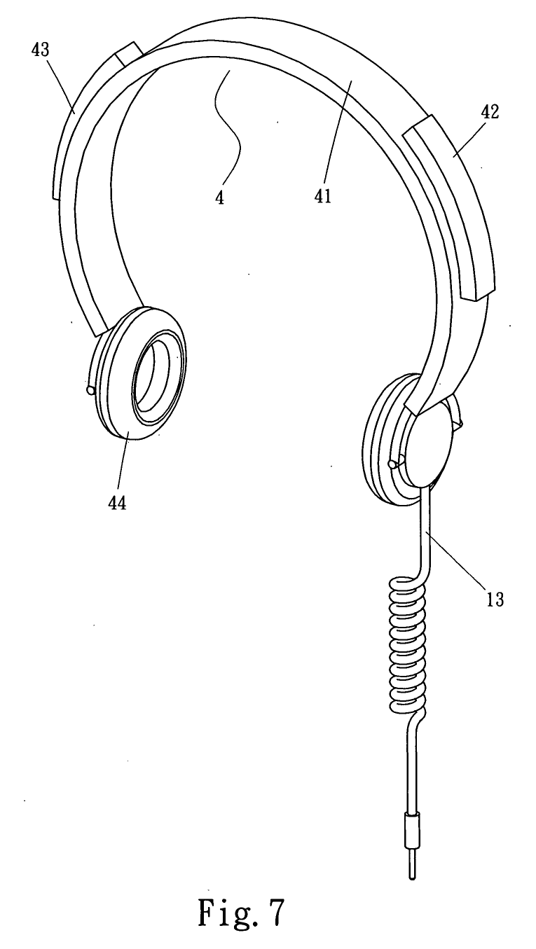

Please refer to FIG. 7 for the actual object according to the preferred embodiment of the invention. A large color illuminating noise-proof earphone 4 is made according to the structure and principle of the invention, so that sportsmen jogging at night, airport ground service staff, tunnel construction workers, road construction workers at night or people working in a dark environment can wear the large color illuminating noise-proof earpiece 4 according to the invention. By means of the functional design of the earpiece, a support frame 41 of the color illuminating noise-proof earpiece 4 has a warning light 42, 43 to produce a constant blinking light for the illuminating earpiece 44 and the earphone illuminating wire 13 in order to achieve the safety warning effect, and prevent any dangerous collision.

In FIG. 1, metal particles 133 or other illuminating materials such as thin metal films and gold thread materials are added into the earphone illuminating wire 13 of the invention to improve the light diffusion effect of the earphone illuminating wire 13.

The illuminating components 112, 113, 114, 115 can be made of different colored LEDs, such that the color illumination effect with different color combinations can be generated.

In summation of the description above, the color illuminating earphone 1 and the principle of using the ear-hanging type earphone 2 or the back-hanging type earphone 3 use the electronic control board 11 of the color illuminating earphone 1 and the control board 11 of an illuminating earplug or earpiece 14 or the circuit control of the circuit board 141 to project the light produced by the illuminating components 112, 113, 114, 115 according to the frequency of the sound source, volume of sound, and a constant blinking function onto the earphone illuminating wire 13, the upper casing 116 of the control board 11, the lower casing 117 of the control board 11, the transparent member 143, and the warning light 41, 42, and then produce radiated lights, so that users may wear the color illuminating earphone having popular and safety warning functions at a concert, with an audio device, or in a dark place.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A color illuminating earphone, comprising an illuminating component disposed in one selected from the collection of an earplug, an earpiece, a control board, and their combinations, an earphone cable wrapped by a transparent material having a light guiding effect, and a chip of said control board providing variations to the illumination of a light source.

2. The color illuminating earphone of claim 1, wherein said illumination effect produces a variation to said light source according to one selected from the collection of frequency, volume, and constant frequency of a sound source.

3. The color illuminating earphone of claim 1, wherein said earphone illuminating wire includes a substance selected from the collection of a metal particle and an illuminating material to enhance a light diffusion effect of said earphone illuminating wire.

4. The color illuminating earphone of claim 1, wherein said electronic circuit control board comprises a battery set for supplying electric power to said control board for the operation of said illuminating components disposed on said control board.

5. The color illuminating earphone of claim 1, wherein said illuminating component is used selectively in an ear-hanging type earphone and a back-hanging type earphone to illuminate said illuminating wire and said illuminating earpiece.

6. The color illuminating earphone of claim 1, wherein said illuminating components are used in a large color illuminating noise-proof earphone, so that said warning light, earpiece, and earphone cable produce a constant blinking light.
